(19) United States
(12) Patent Application Publication
(10) Pub. No.: US 2002/0008929 A1
(43) Pub. Date: Jan. 24, 2002

(54) Method of and apparatus for allocating recording space on a recording medium

(76) Inventors: Edwin Andre Montie, Eindhoven (NL); Adrianus Johannes Maria Denissen, Eindhoven (NL); Ronald Marcel Tol, Eindhoven (NL); Johannes Henricus Maria Korst, Eindhoven (NL)

Correspondence Address: Corporate Patent Counsel, U.S. Philips Corporation, 580 White Plains Road, Tarrytown, NY, 10591, US

(21) Appl. No.: 09/866,439

(22) Filed: May 25, 2001

(30) Foreign Application Priority Data
May 30, 2000 (EP) 00201909.9

(51) Int. Cl. G11B 5/02

(52) U.S. Cl. 360/55

(57) ABSTRACT

A method of and module for allocating recording space on a recording medium for recording an entry of predetermined length, the recording medium having an associated directory (30), which directory (30) lists blocks specifying free space and previously recorded entries, the method comprising the steps of receiving a start position on the recording medium (21), determining with the aid of the directory (30) the consecutive blocks necessary for recording at least the entry of predetermined length, starting from the start position (22), displaying the directory (23) and indicating the consecutive blocks in the directory (24), for example, by a frame (31) around the consecutive blocks. The module may advantageously be included in a video recorder system (10) or another recorder system using recording media.

The present invention relates to a method of and apparatus for allocating recording space on a recording medium. More specifically, the present invention relates to a method of allocating recording space on a recording medium for recording an entry of predetermined length, the recording medium having a directory associated with it, which directory lists blocks specifying free space and previously recorded entries, the method comprising the steps of receiving a start position on the recording medium, determining with the aid of the directory the consecutive blocks necessary for recording at least the entry of predetermined length, starting from the start position, and displaying the directory.

In accordance with a further aspect, the present invention relates to a module for allocating recording space on a recording medium for recording an entry of predetermined length, the module comprising memory means for storing a directory associated with the recording medium, which directory lists blocks specifying free space and previously recorded entries, and processing means connected to the memory means for receiving a start position on the recording medium, and determining the consecutive blocks necessary for recording at least the entry of predetermined length, starting from the start position.

The present invention relates to recording media, such as linear recording media, in which information can only be accessed sequentially. The recording media may, e.g. be audio tape, video tape, for recording information in an analog or in a digital manner, or other data storage media, e.g. for use in computer applications. The recording medium in all these cases is magnetic tape, which is a low cost medium as compared with media for random access devices.

Alternatively, the recording medium may be a random access recording medium, which is used for recording data or information in a sequential format. In this case, the data or information may physically be located on non-sequential parts of the recording medium.

Document WO 93/04473 discloses a method of and system for providing a program directory on a video tape cassette. The directory lists programs recorded on the cassette tape and serves to facilitate allocation and deallocation of space on the tape for recording purposes. The directory may be stored on the tape itself or in an external memory. A user of a video recorder can use the directory to assign space on a video tape for the recording of a certain program. This may be a free space of sufficient length for the program to be recorded. It is also possible to indicate in the directory, that a certain program may be overwritten, without the need to actually erase the program on the tape. For this purpose, the entry in the directory is designated as free space. A tape recorder is then provided with a directory controller including a microprocessor, a memory and a directory input/output keyboard and a display device.

The directory may be displayed on a dedicated screen, or on the TV-screen (On-screen display) in the form of a number of lines, each line representing a recorded program or a free space. The user can select one of the lines, representing either a free space or a previously recorded program, as a start position for recording a new program. Alternatively, the user can enter a program to be recorded and the recording time needed, and the video recorder will then use a search algorithm to find a free space on the tape large enough to record the program. The search algorithm can also be implemented to find an optimum free entry, e.g. one whose length is closest to the length of the program to be recorded.

When there is not enough space on the tape, the user is notified in a following information screen, that subsequent program entries on the tape will be written over when the recording is actually performed.

A disadvantage of this system is that the user is only notified in a following information screen that the program that he wishes to record will overwrite a previously recorded program. If the user wishes to prevent this, he needs to switch back and forth between several information screens in a trial-and-error manner to find a start position for the recording which will only overwrite recorded programs he is not longer interested in keeping.

Document WO 95/18449 discloses a further enhancement of the method and apparatus disclosed in WO 93/04473. The document discloses a method comprising the steps of warning the user when a number of programs already recorded will be overwritten when the program to be recorded is started at the indicated start position. The warning is in the form of a further information screen presented to the user and gives the number and program title of the recorded programs that will be overwritten.

This system has basically the same disadvantage as the system described earlier, namely that the user will have to switch back and forth between various information screens to find an optimum solution for recording a program of predetermined length.

The present invention aims at providing a method of and system for allocating recording space on a recording medium, which does not have the aforementioned disadvantages.

In accordance with a first aspect, the present invention provides a method as defined in the opening part of claim 1, in which the method comprises a further step of indicating the consecutive blocks in the displayed directory.

By means of this method a user is informed directly which program entries and free spaces on a recording medium will be used for recording a new entry of predetermined length from a start position on the recording medium.

The start position may be determined by a search algorithm or in that the start position input is received e.g. from a user. When a user enters a new start position, e.g. by using up/down arrow keys on a keypad, the method will immediately recalculate the consecutive blocks in the directory needed for the recording of a new entry, enabling a very direct interaction with the user. The user is in a better position to intuitively determine the best possible solution for allocating recording space for a new entry, taking into account the other previously recorded entries on the recording medium and their relative importance to the user.

Preferably, the directory is displayed in a text-only format, allowing very easy implementation of the method. The consecutive blocks may be indicated such a manner that they are discernable from the rest of the displayed directory, e.g. by either displaying a frame around the consecutive blocks, highlighting or underlining the consecutive blocks, or by a colour, font, character size or typography different from the other directory blocks. All these alternatives are easy to implement using known means.

The entry to be recorded may relate to a recording of a program on video tape, in which case the predetermined length corresponds to an amount of recording time. Alternatively, the entry to be recorded may relate to recording data (e.g. recording instrumentation data), in which case the predetermined length corresponds to an amount of data.

In a further variant of the present method, the method comprises a further step of calculating the difference between the length of the consecutive blocks and the predetermined length, and displaying the difference. This may aid the user in determining the optimum solution for the allocation of recording space.

In accordance with a further aspect, the present invention provides a module as defined in the opening part of claim 10, in which the processing means are adapted to indicate the consecutive blocks in the directory. The module may form part of a video recorder system, or another recorder system using a recording medium, such as an instrumentation data recorder. The processing means of the module according to the present invention can be adapted advantageously to implement the method according to the present invention.

In accordance with yet another aspect, the present invention relates to a computer program product comprising data and instructions to be loaded into a computer, thereby enabling the computer to carry out the method according to the present invention. Furthermore, the invention relates to a data carrier provided with a computer program product according to the present invention.

The present invention will now be described in further detail by means of exemplary embodiments with reference to the accompanying drawings in which:

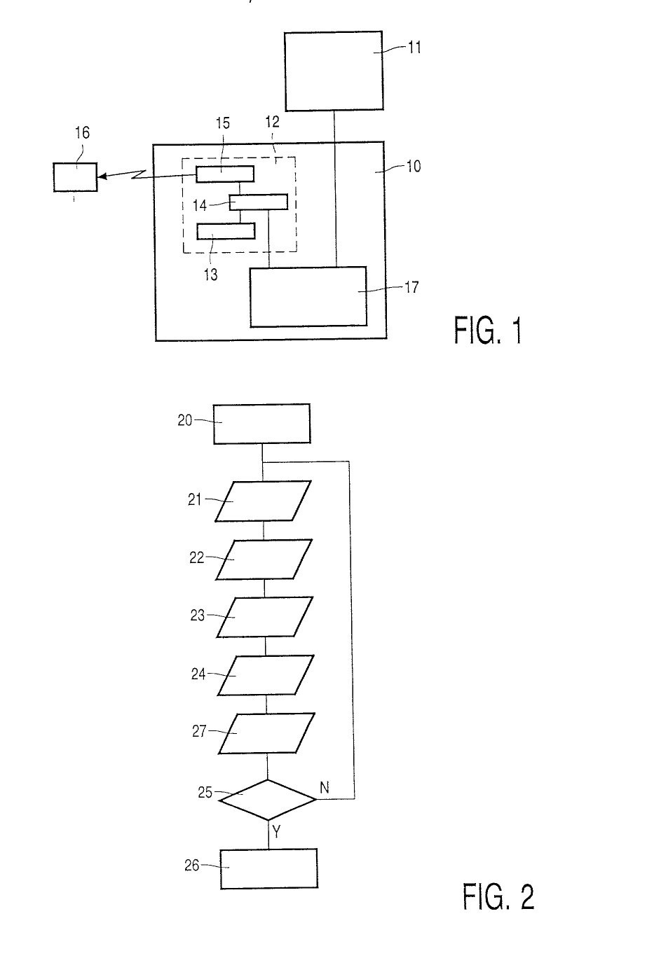

FIG. 1 shows a block diagram of a video recorder system connected to a TV-set, the video recorder system including a module embodying the present invention;

FIG. 2 is a flow diagram illustrating a method according to the present invention; and

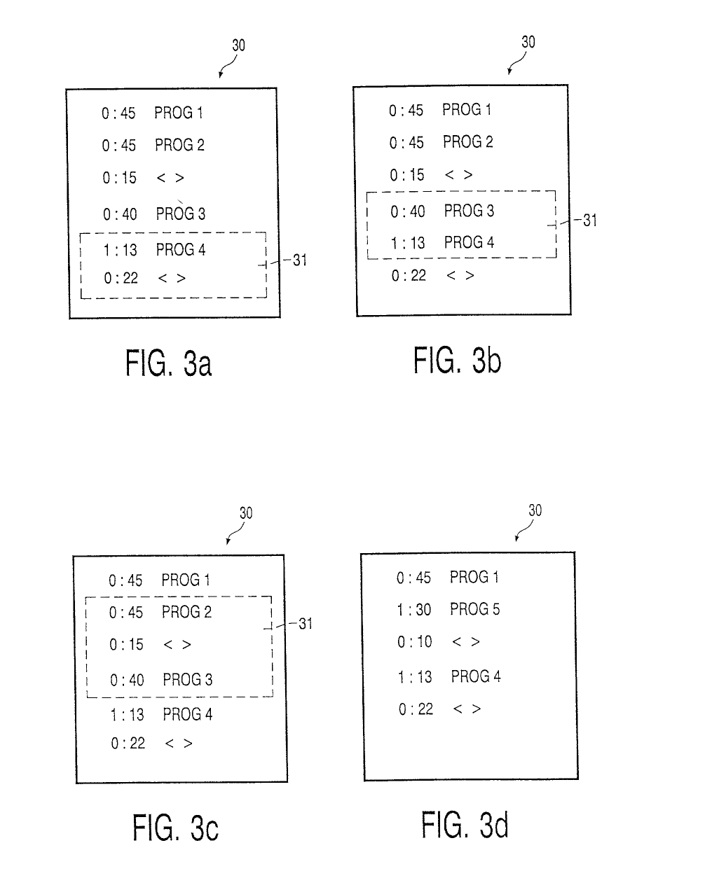

FIGS. 3a-3d show examples of a directory as displayed according to the present invention.

FIG. 1 shows a block diagram of a video recorder system 10 connected to a TV set 11. The video recorder system 10 includes a module 12 according to the present invention, for allocating space on a recording medium, such as a video tape. The module 12 may be a separate item interfacing with the other electronics in the video recorder system 10, or may be implemented as part of the common control electronics in the system 10. The video recorder system 10 further comprises conventional recording/ display means 17, including, amongst other things, the video tape head and associated control means, and output means for delivering a video signal to the TV set 11. The module 12 comprises processing means 14 and memory means 13 connected to the processing means 14. In a further embodiment, the module 12 further comprises interface means 15 connected to the processing means 14 for interfacing with a remote control 16. The module 12 may form part of the video recorder system 10.

In this description, the general term processing means 14 is used to indicate a calculation unit which processes data, such as a computer, under control of software and associated electronics. It may relate to a single processor or multiple processors, or a processor working in parallel to execute multiple methods or programs. The memory means 13 may be formed by known memories, such as RAM, EEPROM or other rewritable memories.

The memory means 13 store data regarding the directory 30 of the video tape which is present in the video recorder system 10. These data may alternatively be stored on the video tape itself, or on a separate storage means on the video tape cassette.

The processing means 14 are adapted to receive a start position on the video tape, either from the conventional recording/display means 17, or via user input. This user input may be achieved, for example, by pressing keys on the remote 16, via the interface means 15. The processing means 14 are further adapted to determine with the aid of the directory 30 the number of consecutive blocks necessary for recording a new program, starting from the start position. Furthermore, the processing means 14 adapted to display the directory 30 and to indicate the number of consecutive blocks in the directory 30, preferably by controlling the conventional recording/display means 17 and the TV set 11 (On screen display).

Alternatively, the processing means 14 may receive data entered by the user via a keyboard or keys on the video recorder system 10. Alternatively, the directory 30 and the indication of the required blocks in the directory 30 may be displayed on a separate display, e.g. on the remote 16, via the interface means 15.

FIG. 2 is a flow diagram of the method according to the present invention, as executed by the processing means 14. Alternatively, the present method is implemented using the processing, memory and display means already present in a modern video recorder system 10. The method according to the present invention may form part of the normal programming method of a conventional video recorder 10. In a step 20 of the method in accordance with the present invention the directory 30 of the video tape present in the video recorder system 10, the title of the program to be recorded and the length of time needed for the recording are received. The directory 30 comprises in sequential form entries about the tape, which may be blocks of free space or previously recorded programs, including the associated lengths of time. In a variant, the directory 30 may also comprise index numbers. In a step 21 the start position on the video tape is received, the position being referenced to the entries in the directory 30. This may be accomplished using a search algorithm for allocating space corresponding to the length of time to be recorded on the video tape, such as known from WO 93/04473 or WO 95/18449. Alternatively, the user provides the start position, e.g. by using up/down or numeric buttons on the remote control 16.

In block 22, the consecutive blocks needed for the program to be recorded are determined, taking into account the start position, the lengths of time associated with the blocks in the directory 30 and the length of the new program to be recorded. In a step 23 this directory 30 is displayed to the user, for example by an on-screen display on the TV-set 11. The consecutive blocks in the directory 30, which are needed for recording the new program, are indicated in the directory 30 in a step 24, for example by putting a frame 31 around the consecutive blocks, by highlighting the consecutive blocks, or by using a different color from the other entries in the directory 30.

In a further variant the method comprises a further step of calculating the difference between the lengths of the consecutive blocks and the predetermined length and of displaying the difference (step 27). This may aid the user in determining the optimum solution for the allocation of recording space.

In a step 25 the user can accept the provisional programming of the new recording as indicated by the present method. If the user accepts the current programming, the method proceeds as usual for the recording of programs. If the user is not satisfied with the selection, the method returns to the step 21, and the user may select a new start position, for example by pressing up-down arrow keys on his remote control 16, or by selecting an index number from the directory 30.

As an example, FIGS. 3a-3d show a directory 30 as presented to a user who wishes to record a program Prog 5 of 1 hour and 30 minutes on a video tape already containing previously recorded programs Prog 1-Prog 4. FIG. 32 shows in a sequential manner the directory 30 of a four hour video tape. The tape contains four previously recorded programs Prog 1-Prog 4, where Prog 1-Prog 4 may be, for example, the titles of the programs. The directory 30 also lists the free spaces available on the tape (here 15 and 22 min.). Furthermore, the length of each entry (program or free space) is shown to the left.

When the user has entered the title of the program to be recorded and its length in hours and minutes, the method according to the present invention may execute a search algorithm to find the most appropriate start position for the recording of the program. In this case, it is found that the most ideal start position would be the start of Prog 4, using the longest free space on the tape, and only sacrificing one previously recorded program. This is indicated in the directory 30 by a frame 31 around the entries in the directory 30 envisaged for the recording.

According to the present method, the user may alter the choice of the start position for the recording of the new program. This may be accomplished by a single keystroke on the remote control 16 for the video recorder, e.g. by using an up-arrow key. After selection of the key, the method determines once again which entries in the directory 30 are needed to be able to record the new program entirely. This is indicated in FIG. 3b, where the start position for the recording has been shifted to the start of Prog 3. The method determines the allocation for the new program, which is marked by the frame 31 around Prog 3 and Prog 4 in the directory 30, which together provide enough space for the new recording.

However, the user may want to keep the recording of Prog 4, and again selects the up-arrow key. Once again, the method determines the allocation of space on the tape for the new program, and indicates the new selection in the directory 30. FIG. 3c shows that in this case, the entries of Prog 2, the free space of 15 minutes and Prog 3 are needed to allow complete recording of the new program. When the user agrees to losing previous recordings Prog 2 and Prog 3, he can accept the selection made at this point, and the new program will be recorded on the video tape after Prog 1.

FIG. 3d shows how in this case the directory 30 will be presented after the new program has been recorded. It is clear that the new program Prog 5 has been recorded after Prog 1, and that a free space of 10 minutes is still available after the recording of Prog 5. Alternatively, the directory 30 of FIG. 3d may also be displayed before the actual recording of the new program, for example with a further indication “preliminary”.

For the person skilled in the art it will be clear that the start position as described above may also be used as the end position, which denotes the end of a recording. In that case, the present method will determine which entries in the directory before the end positon are necessary to enable the desired recording to be made.

By means of the present invention the user can very easily see the various possibilities of allocating space for a new recording, which makes it possible to come to the best solution in a very intuitive way, taking into account the previously recorded programs and their relative importance.

The present invention has been illustrated with reference to a video recorder system 10 and its operation. However, it will be clear that the present invention can also be applied to other recording means, such as instrumentation data recorders. Moreover, the present invention can also be applied using other recording media, e.g. random access recording media, such as a hard disk.

In the case of a hard disk, data or information may be recorded using files on the hard disk, as in a personal computer. When separate files are stored on the disks as a sequence of blocks, the hard disk is virtually a linear recording medium. The blocks forming the file may, however, also be recorded physically spread over the hard disk. The present invention may then be used for the directory of the files. The user can use the frame 31 to mark the files which may be overwritten for a new recording.

In the last-mentioned case, the free blocks are preferably not shown in the directory. When a user wishes to record a program of two hours, and free blocks are present having a recording capacity of one hour, the frame 31 will now indicate consecutive programs having a recording capacity at least one hour. During recording the free blocks will be used first, after which the programs selected by the frame 31 are overwritten.

1. A method of allocating recording space on a recording medium for recording an entry of predetermined length, the recording medium having an associated directory (30), which directory (30) lists blocks specifying free space and previously recorded entries, the method comprising the steps of
receiving a start position on the recording medium (step 21);
determining with the aid of the directory (30) the consecutive blocks necessary for recording at least the entry of predetermined length, starting from the start position (step 22); and
displaying the directory (step 23), characterized in that the method comprises a further step of indicating the consecutive blocks in the displayed directory (step 24).

2. A method according to claim 1, in which the start position is determined by a search algorithm.

3. A method according to claim 1, in which the start position is determined in that start position input is received from a user.

4. A method according to claim 1, 2 or 3, in which the directory (30) is displayed in a text-only format.

5. A method according to any one of the preceding claims, in which the consecutive blocks are displayed so as to be discernable from the rest of the displayed directory.

6. A method according to claim 5, in which the consecutive blocks are indicated by displaying a frame (31) around the consecutive blocks, highlighting or underlining the consecutive blocks, or by a color, font, character size or typography different from the other directory blocks.

7. A method according to any one of the preceding claims, in which the predetermined length corresponds to an amount of recording time.

8. A method according to any one of the preceding claims, in which the predetermined length corresponds to an amount of data.

9. A method according to any one of the preceding claims, in which the method comprises a further step (step 27) of calculating the difference between the lengths of the consecutive blocks and the predetermined length, and of displaying the difference.

10. A module (12) for allocating recording space on a recording medium for recording an entry of predetermined length, the module comprising
memory means (13) for storing a directory (30) associated with the recording medium, which directory (30) lists blocks specifying free space and previously recorded entries; and
processing means (14) connected to the memory means (13) for receiving a start position on the recording medium, and determining the consecutive blocks necessary for recording at least the entry of predetermined length, starting from the start position,
characterized in that the processing means (14) are adapted to indicate the consecutive blocks in the displayed directory (30).

11. A module (12) according to claim 10, in which the processing means (14) are adapted to determine the start position by a search algorithm.

12. A module (12) according to claim 10, in which the processing means (14) are adapted to receive the start position input from a user.

13. A module (12) according to claim 10, 11 or 12, in which the processing means (14) are further adapted to display the directory (30) in a text-only format.

14. A module (12) according to any one of the claims 10 through 13, in which the processing means (14) are further adapted to display the consecutive blocks so as to be discernable from the rest of the displayed directory.

15. A module (12) according to claim 14, in which the processing means (14) are further adapted to indicate the consecutive blocks by displaying a frame (31) around the consecutive blocks, highlighting or underlining the consecutive blocks, or by a color, font, character size or typography different from the other directory blocks.

16. A module (12) according to any one of the claims 10 through 15, in which the processing means (14) are further adapted to calculating a difference between the lengths of the consecutive blocks and the predetermined length, and to display the difference.

17. A video recorder system (10) including a module (12) according to any one of the claims 10 through 16.

18. A computer program product comprising data and instructions to be loaded into a computer, thereby enabling the computer to carry out the method according to any one of the claims 1 through 9.

19. A data carrier provided with a computer program product according to claim 18.
